(19) United States
(12) Patent Application Publication
(10) Pub. No.: US 2020/0074368 A1
(43) Pub. Date: Mar. 5, 2020

(54) SYSTEM AND METHOD TO ASSEMBLY, TRACK, AND ANALYZE MULTI-PERIOD DEALS FORMED FROM MULTIPLE SERVICE OFFERINGS

(71) Applicant: Jason L. Klemow, Gaithersburg, MD (US)

(72) Inventor: Jason L. Klemow, Gaithersburg, MD (US)

(21) Appl. No.: 16/545,889

(22) Filed: Aug. 20, 2019

Related U.S. Application Data
(60) Provisional application No. 62/725,396, filed on Aug. 31, 2018.

(51) Int. Cl. G06Q 10/06

(52) U.S. Cl. CPC G06Q 10/06313; G06Q 10/067

(57) ABSTRACT

Methods and systems to track services outcomes over the lifespan of a deal. The method can include generating service outcomes within a multi-period deal corresponding to a physical process, the representation defining for each period of the deal at least one outcome performed during the process. The method also can include associating the effort required to resolve at least one outcome and can include the delivery costs associated with the effort for each period based across different delivery zones performed during the process. The method can further include optimizing, based upon actual efforts and costs, deal execution for both individual deals and the entire deal portfolio.

### REFERENCE TO RELATED APPLICATIONS

This application claims priority to U.S. Provisional Application No. 62/725,396 entitled “SYSTEM AND METHOD TO ASSEMBLY, TRACK, AND ANALYZE MULTI-PERIOD DEALS FORMED FROM MULTIPLE SERVICE OFFERINGS” filed Aug. 31, 2018, the entirety of which are hereby incorporated by reference.

### FIELD OF THE INVENTION

The invention is directed to the field of managed service deals and, in particular, to the assembling, tracking, and analyzing multiple service outcomes over multiple periods of time.

### BACKGROUND OF THE INVENTION

Broadly defined a deal is a collection of services consisting of multiple service elements in which activity occurrences are determined and efforts to resolve various outcomes are defined and executed based on repeatable patterns supported by deal parameters across delivery zones.

Once a service offering has been deconstructed into its service elements, activities, and outcomes, statistical data pertaining to various aspects of the service can be readily calculated and analyzed. A systematic analysis of the data can suggest ways to delivery and improve the services. To date, however, the available tools have not adequately provided a mechanism by which a financial model and the service can be integrated to efficiently and effectively manage and track services over time, perform simulation, and measure performance.

### SUMMARY OF THE INVENTION

The present invention overcomes the problems and disadvantages associated with current strategies and designs and provides new devices and methods for assembling, tracking and analyzing multi-period deals formed from multiple services.

One embodiment of the invention is to directed to enhancing such assembling, tracking and analyzing by integrating the deal with a financial model that incorporates Outcome-activity-associating module for associating effort required to resolve each outcome performed for each period of the deal and a Delivery-Outcome-associating module for associating costs to resolve each outcome performed for each period of the deal across different delivery zones.

Another embodiment of the invention is directed to a process method for assembling deals. The system preferably includes a deal-generating module for generating multi-period deals corresponding to a services offering, consisting of multiple service elements in which activity occurrences are determined. Additionally, the system preferably includes an Outcome-activity-associating module for associating effort required to resolve each outcome performed for each period of the deal. Additionally, the system preferably includes a Delivery-Outcome-associating module for associating costs to resolve each outcome performed for each period of the deal across different delivery zones.

Another embodiment of the invention is directed to methods for assembling deals. The method can include a deal-generating module for generating multi-period deals corresponding to a services offering, consisting of multiple service elements in which activity occurrences are determined and efforts to resolve various outcomes are defined across different delivery zones.

Another embodiment of the invention is directed to a computer-readable storage medium in which is embedded computer-readable code. The computer-readable storage medium can be configured to cause the computer, when the computer-readable code is loaded in and executed by the computer, to generate a multi-period deal corresponding to service outcomes, associate at least one delivery-based cost with each activity performed during the period, and estimate a distribution of costs over the period of the deal.

Another embodiment of the invention is directed to a method of assembling, tracking and analyzing a model of a financial deal. The method comprises the steps of generating a multi-period deal, associating at least one effort-based outcome with each activity performed during the multi-period deal, estimating a distribution of effort over the periods of the deal, associating at least one delivery-based cost with each outcome performed during the multi-period deal, estimating a distribution of costs over the periods of the deal based on delivery data, and outputting a summary of the deal.

The method preferably further comprises determining, based upon the estimated distribution of effort, whether an effort imbalance is associated with at least one period of the deal. The method preferably further comprises tracking a change in the distribution of effort by varying at least one parameter during a tracking of the deal under varying conditions. Preferably the method further comprises minimizing a total effort of the deal using the estimated distribution of efforts and iteratively varying at least one parameter to reflect tracked changes in the deal. The method preferably further comprises determining, based upon the estimated distribution of costs, whether a cost imbalance is associated with at least one period of the deal.

Preferably, the method further comprises tracking a change in the distribution of costs by varying at least one parameter during a tracking of the deal under varying conditions. The method preferably further comprises minimizing a total cost of the deal using the estimated distribution of costs and iteratively varying at least one parameter to reflect tracked changes in the deal. The method preferably further comprises estimating a total revenue generated by a tracked completion of the deal, and maximizing an estimated profit by tracking changes in the deal by varying at least one parameter of the deal, wherein the tracked change iteratively varies among at least one of the estimated total revenue, the estimated distribution of efforts, and the estimated distribution of costs.

Preferably the method further comprises specifying one or more parameters as a price-per-unit of a resource used during at least one period of the deal, iteratively varying the price-per-unit, and determining corresponding changes in the distribution of costs based upon changes in the price-per-unit. The method preferably further comprises associating at least one resource constraint with at least one period of the deal and tracking a change in the process by varying the at least one resource constraint and determining for each tracked change in the deal a corresponding change in the distribution of costs.

Another embodiment of the invention is directed to a system of assembling, tracking and analyzing a model of a financial deal. The system comprises a deal-generating module, an outcome-activity-associating module in communication with the deal-generating module, an effort-estimating module in communication with the deal-generating module and the outcome-activity-associating module, a delivery-outcome-associating module in communication with the deal-generating module, and a delivery-estimating module in communication with the deal-generating module and the delivery-outcome-associating module.

Preferably, the deal-generating module, the outcome-activity-associating module, and the effort-estimating module are at least one of circuitry and software. In a preferred embodiment the deal-generating module is adapted to generate a multi-period deal representation corresponding to a physical process. Preferably, the deal generated by the deal-generating module defines, for each period of the deal, at least one outcome performed during the process. Preferably, the delivery-outcome-associating module matches relevant delivery-based costs corresponding to each of the outcomes performed during the process.

In a preferred embodiment, the delivery-estimating module determines likely changes in distribution of costs resulting from changes in a price-per-unit. Preferably, the delivery-outcome-associating module iteratively varies the price-per-unit of a resource. Preferably, the delivery-estimating module estimates a distribution of costs over each of the periods of the deal based on cost data generated by repeated execution of the process. In a preferred embodiment, delivery-estimating module determines, based upon estimated distribution of costs, whether a cost imbalance is associated with at least one period of the deal. Preferably the system further comprises a tracking module. The tracking module preferably varies at least one resource constraint or a parameter representing the constraint and determines the effect of the constraint as reflected by any corresponding change in the distribution of costs that results or tracks the effects of excess capacity so that resources can be reallocated to improve distribution of costs over the various periods of the deal.

Other embodiments and advantages of the invention are set forth in part in the description, which follows, and in part, may be obvious from this description, or may be learned from the practice of the invention.

### BRIEF DESCRIPTION OF THE DRAWINGS

There are shown in the drawings, embodiments which are presently preferred. It is expressly noted, however, that the invention is not limited to the precise arrangements and instrumentalists shown.

FIG. 1 is a schematic view of a system for assembling deals, according to one embodiment of the invention.

FIG. 2 is a schematic view of outcomes performed at periods of the service and costs associated wherewith, according to another embodiment of the invention.

FIG. 3 is a flowchart of exemplary steps in a method for assembling deals, according to yet another embodiment of the invention.

FIG. 4 is a schematic view of an operative application of a system for assembling deals, according to still another embodiment of the invention.

FIG. 5 is a schematic of an embodiment of a computing device.

### DESCRIPTION OF THE INVENTION

The invention is directed to systems and methods for assembling a deal. Preferably, the systems and methods provide for tracking changes in the deal and determining, based upon the tracked changes, the financial effects of changes to the underlying process. The insights provided by service assembly and tracking of a service modeled as a deal can be significantly enhanced by integrating effort and delivery cost-based information with the deal model.

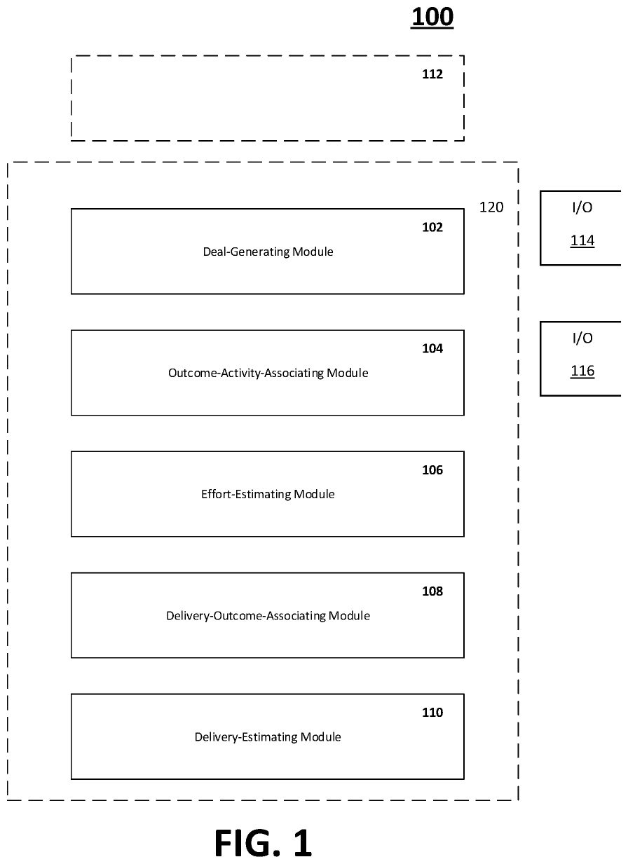

FIG. 1 is a schematic view of a system 100 for assembling a deal according to one embodiment of the invention. Illustratively, the system 100 includes a deal-generating module 102. The system 100 also illustratively includes an outcome-activity-associating module 104 in communication with the deal-generating module 102. Additionally, the system 100 illustratively includes an effort-estimating module 106, also in communication with the deal-generating module 102, as well as with the outcome-activity-associating module 104. The system 100 also illustratively includes a delivery-outcome-associating module 108 in communication with the deal-generating module 102. Additionally, the system 100 illustratively includes a delivery-estimating module 110, also in communication with the deal-generating module 102, as well as with the delivery-outcome-associating module 108.

One or more of the deal-generating module 102, the outcome-activity-associating module 104, and the effort-estimating module 106 can preferably be implemented in hardwired circuitry configured to process data and execute the procedures described herein. Alternatively, however, one or more of the modules 102, 104, 106 can be implemented in computer-executable code configured to execute upon a general-purpose or application specific computing device so as to cause the device to perform the same procedures. Accordingly, the system 100 optionally includes a processor 120 for executing computer-readable code and a memory 112 for storing the computer-readable code along with data processed according to the procedures implemented by the modules 102, 104, 106. The data can be supplied through a standard input/output (I/O) device 114, and the results of the procedures performed on the data can be output on a different I/O device 116 or the same I/O device. In still another embodiment, one or more of the modules 102, 104, 106 can be implemented in a combination of hardwired circuitry and computer-readable code.

Operatively, the deal-generating module 102 generates a multi-period deal representation corresponding to a physical process, whether a managed service or some other service involving multiple outcomes at various periods. The deal generated by the deal-generating module 102, accordingly, defines for each period of the deal at least one outcome performed during the process.

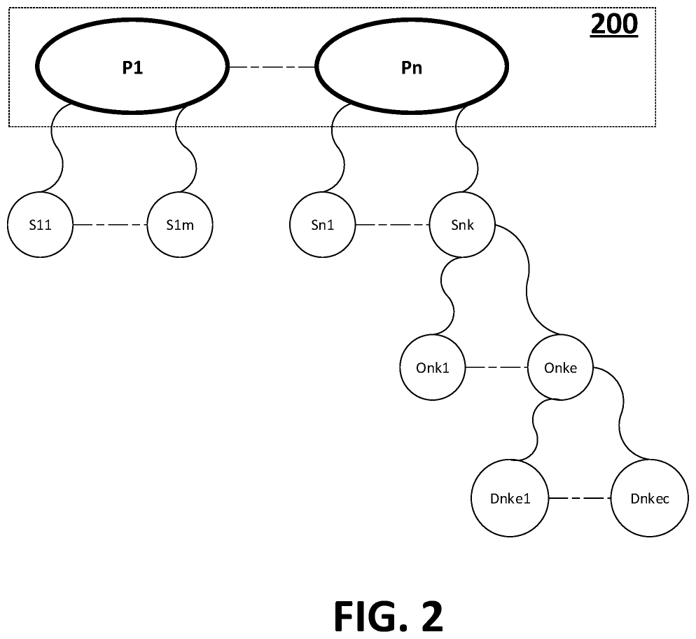

For example, if implemented in computer-readable code in an object-oriented programming environment, the deal-generating module 102 can generate a representation of the deal that includes a class of objects corresponding to each Service. Each Service may be associated with one or more Service Elements, and each Service Element may be associated with one or more Activities, and each Activity may be associated with one or more Outcomes. Each set of Service Elements, Activities and Outcomes can likewise be objects of a subclass and be associated with a particular object corresponding to a particular period of the multi-period deal. Referring additionally now to FIG. 2, the periods of an n-period deal 200 are represented by objects P1 through Pn. One or more Services is performed at each period. At period 1, for example, m Service are performed these being schematically shown as objects S11 through S1m. At the n-th period of this exemplary deal 200, k Services are performed. The n-th period Services are schematically shown as objects Sn1 through Snk. As described more particularly in the following, one or more outcomes is associated with each service performed at a particular period of the deal 200. At the n-th period of this exemplary deal 200, e Outcomes are performed. The n-th period Outcome are schematically shown as objects Onk1 through Onke. As described more particularly in the following, one or more efforts is associated with each outcome performed at a particular period of the deal 200.

At the n-th period of this exemplary deal 200, c Deliveries are performed. The n-th period Delivery are schematically shown as objects Dnke1 through Dnkec. As described more particularly in the following, one or more efforts is associated with each outcome performed at a particular period of the deal 200.

The costs associated with a service can include, for example, fixed costs, variable costs of delivery-associated outcome, variable costs based upon time-of-execution of a delivery (generally, for any outcome, the more rapidly an delivery must be performed, the higher the cost of the outcome). Other costs include the opportunity cost of the wait time between two consecutive periods of the deal; that is, the cost of opportunities lost because resources that could be otherwise employed more productively elsewhere, but instead not utilized, or are underutilized, waiting for another delivery to be completed. Still other costs include storage costs associated with a delivery, utilization costs of a resource used in conjunction with an delivery, and an implicit cost of allocated overhead, such as those allocated through capital budgeting techniques.

Regardless of the nature of the costs, the delivery-outcome-associating module 108 matches relevant delivery-based costs corresponding to each of the outcomes performed during the service. Once the delivery-based costs are integrated with the other services of the deal 200, and the deal has been in production for a sufficient period of time, the details of delivery and outcome execution can be assembled to determine a distribution of costs across the various periods of the deal 200. Accordingly, the delivery-estimating module 110 is configured to estimate a distribution of costs over each of the periods of the deal based on cost data generated by repeated execution of the process.

The delivery-estimating module 110 can, according to one embodiment, be further configured to determine, based upon the estimated distribution of costs, whether a cost imbalance is associated with at least one period of the deal. For example, the assembly performed by the system 100 of a particular service offering might reveal that the period at which proactive management service of certain equipment is performed represents a disproportionate share of the total cost of each service through the deal.

The deal-generating module 102 can be further configured to associate at least one parameter with each delivery. The parameter can be a parameter that quantifies the manner in which a particular outcome is performed, for example, or even whether the outcome is performed at all (e.g., a binary variable). The system 100 optionally can further include a tracking module. The tracking module can track a change in the distribution of costs by varying the at least one parameter during a tracking of the service under varying conditions, the variable conditions being reflected by changes in one or more corresponding parameters. Thus, once a change or set of changes to the service are proposed, the system can execute a tracking, collecting cost information from the appropriately modified deal representation. The proposed change, accordingly, can be evaluated in terms of the cost effects that would result from the change. The effects of changes to the manner in which the process is performed are not the only effects that can be considered using the system 100. In still another embodiment, one or more parameters that can be included are those associated with human and non-human resources required during the process, in particular the cost of those resources. For example, the price of automation can have a significant effect with respect to reducing the delivery costs across multiple services. Accordingly, at least one parameter can be a price-per-unit of a resource used during at least one period of the deal. The delivery-outcome-associating module 108 can be configured to iteratively vary the price-per-unit of a resource. The delivery-estimating module 110 can correspondingly determine the likely changes in the distribution of costs resulting from changes in the price-per-unit.

Other effects that can be assembled by the system 100, include resource constraints. For example, the resource capacity of skilled worker groups or specialized tools can impose significant constraints on a service. Some resources are not readily scalable, and thus small or even large variations in resource requirements may not yield corresponding financial benefits. To assess these effects, the system 100 according to still another embodiment can include a tracking module for varying at least one resource constraint, or parameter representing the constraint. It can then be determined the effect of the constraint as reflected by any corresponding change in the distribution of costs that results. Conversely, the tracking module can be configured to track the effects of excess capacity so that resources can be reallocated so as to improve the distribution of costs over the various periods of the deal.

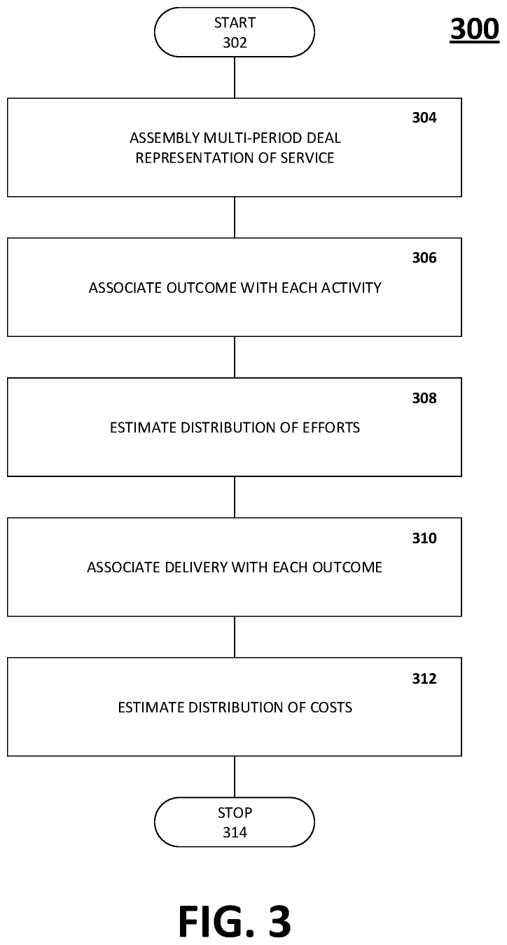

Referring now to FIG. 3, a preferred method of the invention is illustrated by the flowchart of exemplary steps in a method 300 of assembling a deal. As illustrated, after the start at step 302, the method 300 illustratively includes generating a multi-period deal corresponding to a physical service at step 304, the deal can define at each period at least one outcome performed during the service. The method 300 further illustratively includes, at step 306, associating at least one effort-based outcome with each activity performed during the service. At step 308, the method 300 illustratively includes estimating a distribution of effort over the periods of the deal based on outcome data generated by repeated execution of the process.

The method 300 further illustratively includes, at step 310, associating at least one delivery-based cost with each outcome performed during the service. At step 312, the method 300 illustratively includes estimating a distribution of costs over the periods of the deal based on delivery data generated by repeated execution of the process. The method 300 illustratively concludes at step 314 with an outputted summary.

Optionally, the method 300 can further include determining, based upon the estimated distribution of effort, whether an effort imbalance is associated with at least one period of the deal. As already described in the context of a system for assembling a service, at least one parameter can be associated with each outcome of the deal. Accordingly, the method also can include tracking a change in the distribution of efforts by varying at least one parameter during a tracking of the process under varying conditions. Likewise, the method can additionally include minimizing a total effort of the deal using the estimated distribution of efforts and iteratively varying at least one parameter to reflect tracked changes in the process.

Optionally, the method 300 preferably further includes determining, based upon the estimated distribution of costs, whether a cost imbalance is associated with at least one period of the deal. As already described in the context of a system for assembling a process, at least one parameter can be associated with each activity of the deal. Accordingly, the method also can include tracking a change in the distribution of costs by varying at least one parameter during a tracking of the process under varying conditions. Likewise, the method can additionally include minimizing a total cost of the deal using the estimated distribution of costs and iteratively varying at least one parameter to reflect tracked changes in the process.

The method similarly preferably includes estimating a total revenue generated by a tracked completion of the deal, and maximizing an estimated profit by tracking changes in the deal by varying at least one parameter of the deal, wherein the tracked change iteratively varies at least one among an estimated total revenue, the estimated distribution of efforts, and the estimated distribution of costs. The method, moreover, can specify one or more parameters as the price-per-unit of a resource used during at least one period of the deal, and can further comprise iteratively varying the price-per-unit and, in response thereto, determining corresponding changes in the distribution of costs based upon changes in the price-per-unit. The method can further include associating at least one resource constraint with at least one period of the deal and tracking a change in the process by varying the at least one resource constraint and determining for each tracked change in the process a corresponding change in the distribution of costs.

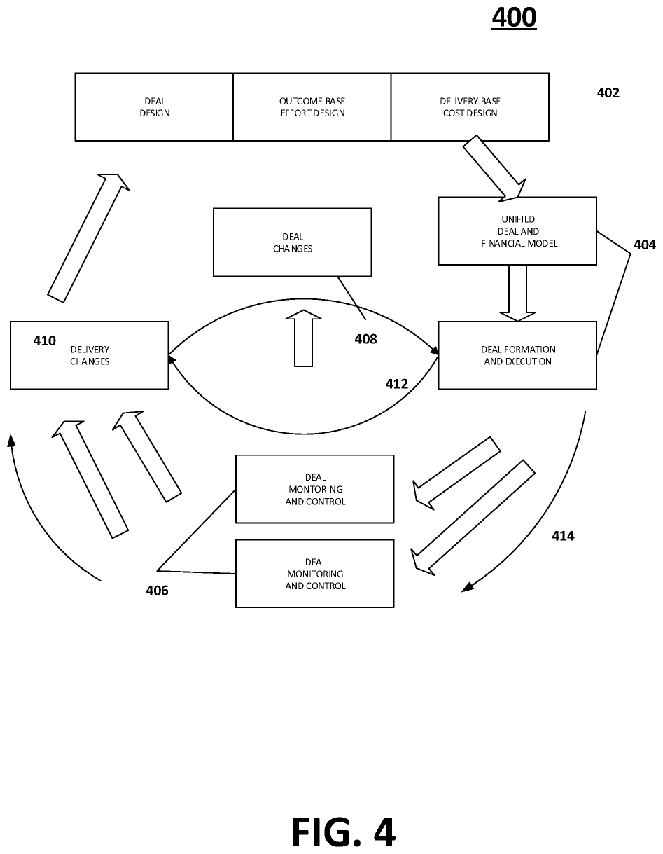

FIG. 4 schematically illustrates an exemplary application of certain aspects of the invention of exemplary steps in a method 400 of assembling a deal. As illustrated, after the start at step 402, the method 400 illustrates a deal is initially designed with outcome-based effort distributions and delivery-based cost distributions are also designed. According to one embodiment, all are built together in a single tool. Effort can be assigned to outcomes based on historical efforts, based on expected occurrences of activities and durations to resolve, and other factors. Costs can be assigned to delivery based on resource costs by role and location and on other factors. Specifically, a deal modeling tool that includes effort modeling tools and cost modeling tools is utilized. The method 400 further illustratively includes, at step 404, the unified deal model and financial cost model are deployed to a deal system as a functional application and executed. Each execution accumulates a deal audit trail, as well as detailed effort and cost information. The information is then fed to two types of monitoring/controlling flows—deal and financial-which can be performed by different groups.

Effort and Cost data and deal audit data, at step 406, are used in both the deal monitoring and controlling applications and also fed to financial monitoring and controlling applications. First, the deal tools are used to evaluate the structure of the deal, to determine whether any adjustments are required during deal formation. Statistics are obtained over the life of the proposed deal, such as number of activity occurrences, number of times each outcome is resolved, resource efforts, and so on, across multiple periods, as well as summary data gathered in the deal. These are data items that can be used for decision-making prior to deal execution.

By providing effort and cost information from the financial model embedded in the deal, the deal monitoring and controlling applications can present for analysis not just the number of activity occurrences, but expected effort and cost data by service and resource. This would allow a service owner, for example, to make evaluations and adjust the deal based on the real effort and cost of the work. The owner can determine, for example, that a certain outcome is performed twice as frequently as another and take action to automate the delivery. However, based upon cost information, it might be revealed that the cost of the more frequently executed step is only 0.4 times the cost of automation and thus automation actually costs 25% more. According to one aspect of the invention, this and other types of cost data presented in the deal monitoring tool enhances subsequent assembly, tracking, and analysis of the deal, making such assembly, tracking, and analyzing far more relevant to decision makers.

Additionally, the financial model optionally can include resource behavior that can span multiple services, such as the ability of the organization to usefully absorb surpluses. The tracking and assembly tools thus are able to provide better information about the possible impact of any proposed change in the deal. For example, a proposed change to the deal might reduce the need for a particular resource, but if the surplus resource cannot be utilized, then there is no actual financial benefit to the change. In another example, a proposed change to a deal might require slightly more of a particular resource. If that resource is at capacity, then the change cannot be implemented, or must be implemented with a higher cost (outsourcing, or the cost of ramping up that resource).

When changes are made to the deal that rearrange the use of existing resources, the financial model that is connected to the deal can be automatically adjusted. Automatic adjustment allows the sometimes frequent changes to a deal in production to continuously reflect current cost data to the monitoring and controlling tools.

The method 400 further illustratively includes, at step 406, the actual effort and actual cost data generated in the deal post execution are also provided to financial monitoring tools. These are typically utilized by financial analysts and other decision makers concerned, for example, with the financial implications of decisions pertaining to the deal and more broadly to the organization carrying out the process. That is, the cost data, like other financial information, can be used to monitor a business or other organization as a whole. A distinct benefit is that current data is obtained and continuously updated cost modeling based on changes to deal at the business unit or departmental level is provided.

Deal changes are illustratively made at step 408. The method 400 further illustratively includes, at step 410, decisions pertaining to delivery changes can be made based on feedback involving the effort distribution and/or the cost distribution. This allows the financial group in the company to monitor the cost outputs of the deal systems and make global changes to the distribution of costs. Typically, there are a great many different deals operating in a company, and each one contributes costs and consumes resources. An organization should have a facility for rolling up and distributing down the various costs and resource constraints. From a global financial perspective, a model of costs, activities, and distributions can be built. This global model can be used in the development of the individual deal/financial models. The output of each deal is a set of costs that can be rolled up and then compared with the global model. A financial analyst can review the data and make changes to the global financial model. This would then automatically be distributed into each deal, and so on.

Preferably, there are two feedback loops that are implemented in method 400. The first is the inner loop 412, which is local to each deal during the formation stage. In this inner loop 412, the deal runs, and a decision maker monitors the deal, analyzes results, tracks changes, and adjust the deal prior to execution. This is a fairly rapid loop and many deals are tweaked frequently in this way. Incorporating cost data is a valuable addition that enhances procedures for analyzing deal formation at the individual service level.

The second feedback loop 414 which is local to each deal post formation in the execution over multi-periods. The second loop 414 starts with the executed deal and planned effort and cost data in each of the periods. As the deals run, the actual efforts and cost are used as inputs to a deal monitoring and controlling application. This can be used to analysis and compare the planned deal effort and costs with actual data, which in turn produces more refined results for this local deal and future deals.

The afore-mentioned delivery changes referred to with respect to step 410 can represent any change to the deal as a result of tracking and analysis. Thus, according to one embodiment, there can be two sources of change. One pertains to the inner loop 412 and stems from assembly, tracking, and/or analysis during deal formation and deal changes. The other, pertaining to the outer loop 414, and stems from assembly changes, tracking, and/or analysis of actual effort and cost date to actuals.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

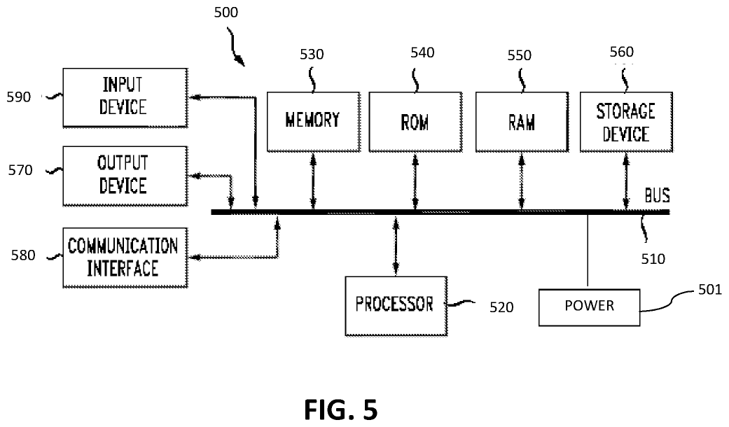

FIG. 5 depicts a schematic of a preferred embodiment of a computing device 500. Device 500 preferably includes a power source 501. For example, power source 501 may be a battery, a chemical power source, a solar energy converter, a power converter to receive power from a wall receptacle or the like, a mechanical power source, or source of power.

Power source 501 is preferably used to supply power to the remaining components of computing device 500. Computing device 500 preferably further includes an integrated circuit (i.e. a system on a chip (SoC)). The SoC preferably integrates multiple components of a computer or other electronic system into a single chip. It may contain digital, analog, mixed-signal, and radio-frequency functions all on a single chip substrate. The SoC preferably incorporates one or more of a central processing unit (CPU), a graphics processing unit (GPU), and a system bus 510 that couples various system components including the system memory 530, dynamic random access memory (RAM) 550 and flash memory 560, to the SoC. The system bus may be one of several types of bus structures including a memory bus or memory controller, a peripheral bus, or a local bus using one of a variety of bus architectures. A basic input/output (BIOS) stored in flash memory 560 or the like, may provide the basic routine that helps to transfer information between elements within computing device 500, such as during start-up. The drives and the associated computer readable media provide nonvolatile storage of computer readable instructions, data structures, program modules and other data for computing device 500. The basic components are known to those of skill in the art and appropriate variations are contemplated.

Although the exemplary environment described herein employs flash memory, it is appreciated by those skilled in the art that other types of computer readable media which can store data that are accessible by a computer, such as magnetic cassettes, hard drives, digital versatile disks, cartridges, random access memories (RAMs) 550, read only memory (ROM) 540, a cable or wireless signal containing a bit stream and the like, may also be used in the exemplary operating environment.

Computing device 500 further preferably includes a networking device 580. Networking device 580 is able to connect to, for example, the Internet, one or more Local Area Networks (“LANs”), one or more Metropolitan Area Networks (“MANs”), one or more Wide Area Networks (“WANs”), one or more Intranets, etc. Networking device 580 may be capable of connecting to wireless Bluetooth devices (e.g. a keyboard or a mouse). Preferably, networking device 580 is a wireless networking device (e.g. Wi-Fi), however hard-wired networks can be coupled to networking device 580 (e.g. ethernet). Furthermore, networking device 580 may also connect to distributed computing environments where tasks are performed by local and remote processing devices that are linked (either by hardwired links, wireless links, or by a combination thereof) through a communications network. In a distributed computing environment, program modules may be located in both local and remote memory storage devices.

To enable user interaction with computing device 500, there is preferably an input receiving device 590. Input receiving device 590 can receive input from a number of input mechanisms, such as a microphone for speech, a touch-sensitive screen for gesture or graphical input, a keyboard, a mouse, motion input, RJ-45, USB, and so forth. In some instances, multimodal systems enable a user to provide multiple types of input to communicate with the computing device 500. There is no restriction on the invention operating on any particular hardware arrangement and therefore the basic features here may easily be substituted for improved hardware or firmware arrangements as they are developed.

Computing device 500 further preferably includes at least one output port 570. Output port 570 connects computing device 500 to a TV, speaker, projector, or other audio-visual device. Preferably, output port 570 is a HDMI port, optical audio port, serial port, USB port, networking port, s-video port, coaxial cable port, composite video, composite audio, and/or VGA port. In preferred embodiments, computing device 500 may also include additional auxiliary components (e.g. power management devices or digital audio convertors).

For clarity of explanation, the illustrative system embodiments are presented as comprising individual functional blocks. The functions these blocks represent may be provided through the use of either shared or dedicated hardware, including, but not limited to, hardware capable of executing software. For example, the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large-scale integration (VLSI) hardware embodiments, as well as custom VLSI circuitry in combination with a general purpose DSP circuit, may also be provided.

Embodiments within the scope of the present invention include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a computer, specialty computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A method of assembling, tracking and analyzing a model of a financial deal, comprising:
generating a multi-period deal;
associating at least one effort-based outcome with each activity performed during the multi-period deal;
estimating a distribution of effort over the periods of the deal;
associating at least one delivery-based cost with each outcome performed during the multi-period deal;
estimating a distribution of costs over the periods of the deal based on delivery data; and
outputting a summary of the deal.

2. The method of claim 1, further comprising determining, based upon the estimated distribution of effort, whether an effort imbalance is associated with at least one period of the deal.

3. The method of claim 1, further comprising tracking a change in the distribution of effort by varying at least one parameter during a tracking of the deal under varying conditions.

4. The method of claim 1, further comprising minimizing a total effort of the deal using the estimated distribution of efforts and iteratively varying at least one parameter to reflect tracked changes in the deal.

5. The method of claim 1, further comprising determining, based upon the estimated distribution of costs, whether a cost imbalance is associated with at least one period of the deal.

6. The method of claim 1, further comprising tracking a change in the distribution of costs by varying at least one parameter during a tracking of the deal under varying conditions.

7. The method of claim 1, further comprising minimizing a total cost of the deal using the estimated distribution of costs and iteratively varying at least one parameter to reflect tracked changes in the deal.

8. The method of claim 1, further comprising estimating a total revenue generated by a tracked completion of the deal, and maximizing an estimated profit by tracking changes in the deal by varying at least one parameter of the deal, wherein the tracked change iteratively varies among at least one of the estimated total revenue, the estimated distribution of efforts, and the estimated distribution of costs.

9. The method of claim 1, further comprising:
specifying one or more parameters as a price-per-unit of a resource used during at least one period of the deal;
iteratively varying the price-per-unit; and
determining corresponding changes in the distribution of costs based upon changes in the price-per-unit.

10. The method of claim 1, further comprising associating at least one resource constraint with at least one period of the deal and tracking a change in the process by varying the at least one resource constraint and determining for each tracked change in the deal a corresponding change in the distribution of costs.

11. A system of assembling, tracking and analyzing a model of a financial deal, comprising:
a deal-generating module;
an outcome-activity-associating module in communication with the deal-generating module;
an effort-estimating module in communication with the deal-generating module and the outcome-activity-associating module;
a delivery-outcome-associating module in communication with the deal-generating module; and
a delivery-estimating module in communication with the deal-generating module and the delivery-outcome-associating module.

12. The system of claim 11, wherein the deal-generating module, the outcome-activity-associating module, and the effort-estimating module are at least one of circuitry and software.

13. The system of claim 11, wherein the deal-generating module is adapted to generate a multi-period deal representation corresponding to a physical process.

14. The system of claim 13, wherein the deal generated by the deal-generating module defines, for each period of the deal, at least one outcome performed during the process.

15. The system of claim 14, wherein the delivery-outcome-associating module matches relevant delivery-based costs corresponding to each of the outcomes performed during the process.

16. The system of claim 11, wherein the delivery-estimating module determines likely changes in distribution of costs resulting from changes in a price-per-unit.

17. The system of claim 11, wherein the delivery-outcome-associating module iteratively varies the price-per-unit of a resource.

18. The system of claim 13, wherein the delivery-estimating module estimates a distribution of costs over each of the periods of the deal based on cost data generated by repeated execution of the process.

19. The system of claim 18, wherein delivery-estimating module determines, based upon estimated distribution of costs, whether a cost imbalance is associated with at least one period of the deal.

20. The system of claim 11, further comprising a tracking module, wherein the tracking module:
varies at least one resource constraint or a parameter representing the constraint; and
determines the effect of the constraint as reflected by any corresponding change in the distribution of costs that results; or
tracks the effects of excess capacity so that resources can be reallocated to improve distribution of costs over the various periods of the deal.
